(19) United States
(12) Patent Application Publication
(10) Pub. No.: US 2014/0311827 A1
(43) Pub. Date: Oct. 23, 2014

(54) MAN BASKET

(71) Applicants: Paul S. Smith, Drayton Valley (CA); Danny S. Smith, Drayton Valley (CA); Gregory A. Hartman, Drayton Valley (CA)

(72) Inventors: Paul S. Smith, Drayton Valley (CA); Danny S. Smith, Drayton Valley (CA); Gregory A. Hartman, Drayton Valley (CA)

(21) Appl. No.: 13/866,872

(22) Filed: Apr. 19, 2013

(51) Int. Cl. A62B 1/06

(52) U.S. Cl. CPC A62B 1/06
USPC 182/113

(57) ABSTRACT

An elevated platform for rapid evacuation has a cage having a floor and a railing, one or more suspension points secured to an upper portion of the cage above the floor and an eyelet secured to the cage for receiving a descender, the eyelet being positioned in relation to the cage such that a line drawn downward from the eyelet does not intersect the cage.

### TECHNICAL FIELD

Man baskets.

### BACKGROUND

Man baskets are used to hold workers in the air with the man basket lifted by a crane or picker or the like. In the case of an emergency, the worker needs to be able to evacuate the man basket quickly.

### SUMMARY

An elevated platform, such as a man basket, is disclosed for rapid evacuation. In an embodiment, an elevated platform is provided comprising a cage having a floor and a railing, one or more suspension points secured to an upper portion of the cage above the floor and an eyelet secured to the cage for receiving a descender, the eyelet being positioned in relation to the cage such that a line drawn downward from the eyelet does not intersect the cage.

In various embodiments, there may be included any one or more of the following features: the eyelet is secured to a davit; the davit comprises a davit post extending upward from the cage; the davit post is secured to a corner of the cage; the davit includes a davit arm, the eyelet is on the davit arm and the davit arm extends outward from the cage by at least 20 cm to space the eyelet from the cage by at least 20 cm; the davit post is pivotally attached to the cage; the davit post pivots from a vertical position to a horizontal position; in the horizontal position, the davit post lies along the railing of the cage; in the vertical position, the davit post is held upright by a brace secured to the davit post by a pin; the cage has a door with a hinge side and a closure side; the eyelet is located adjacent the door at the hinge side of the door or the closure side of the door; the eyelet is located at the hinge side of the door; the door is hinged to a corner post of the cage and the davit post extends upward from the corner post; the cage is rectangular with opposed longer sides and shorter sides and the door is on one of the longer sides of the cage; the one or more suspension points comprises a connector on a suspension frame that is pivotally attached to the cage; the cage has opposed shorter sides and longer sides, and the one or more suspension points comprises a connector on a suspension frame that is pivotally attached to the cage on the shorter sides of the cage.

These and other aspects of the device are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a first perspective view of an embodiment of an elevated platform with davit down;

FIG. 2 is a second perspective view of an embodiment of an elevated platform with davit down;

FIG. 3 is a third perspective view of an embodiment of an elevated platform with davit up;

FIG. 4 is a fourth perspective view of an embodiment of an elevated platform with davit up;

FIG. 5 is a perspective view of the embodiment of the elevated platform of FIG. 1 with a worker in position for evacuation.

### DETAILED DESCRIPTION

Above, upper, upward, downward, below, horizontal and vertical are defined in relation to the normal operational position of the elevated platform. The exemplary elevated platform is a man basket, but the davit may be used with other elevated platforms such as a ski chair, high rise building or tower.

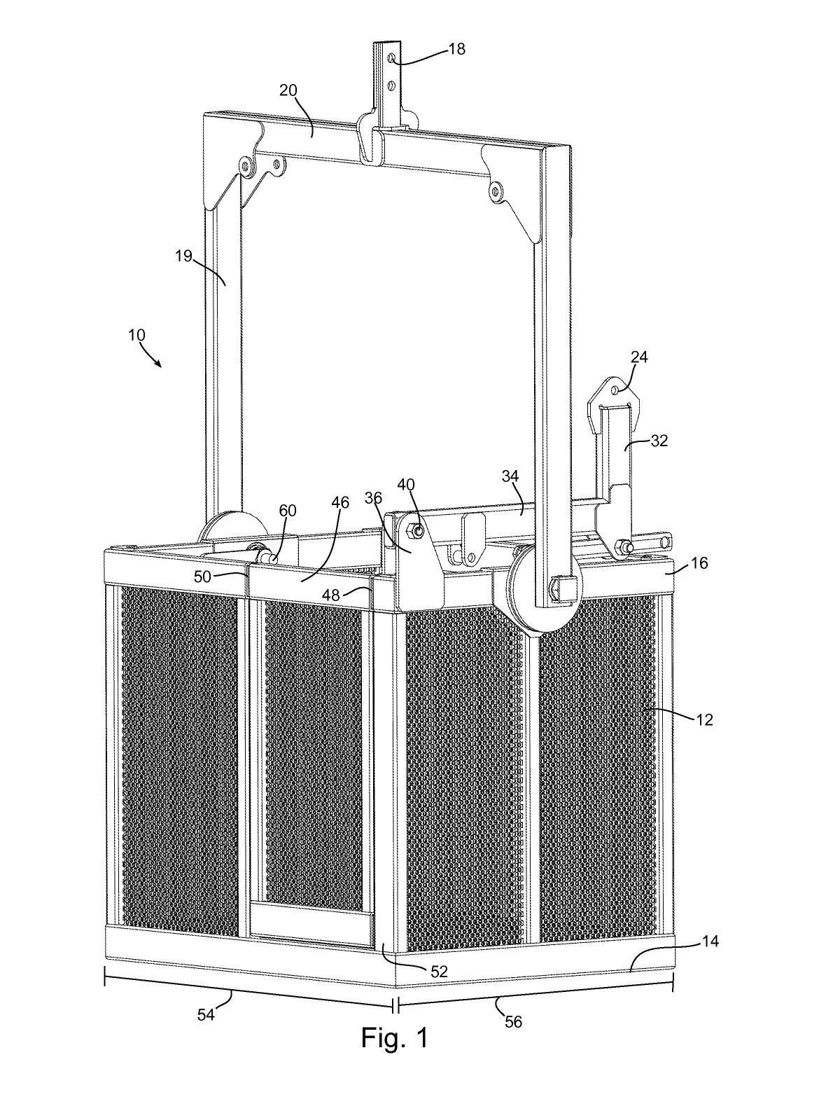

Referring to FIGS. 1-4, there is shown an elevated platform 10 comprising a cage 12 having a floor 14 and a railing 16. In various embodiments, the elevated platform 10 may have different construction and shape. One or more suspension points 18 are secured to an upper portion 20, in this case the railing 16, of the cage 12 above the floor 14. The suspension point 18 may be a connector for connecting to the boom of a picker on a suspension frame 19, or may have other forms such as being one or more eyelets that connect to a cable. For example, in some cages 12, the suspension point 18 may be eyelets at four corners of the cage 12 that connect to cables, which cables meet at a common point that is then connected to the device that hoists or elevates the elevated platform. The railing 16 may be secured to the floor 14 in any of various ways, such as by posts, or the railing could be the upper surface of a wall that is secured to the floor.

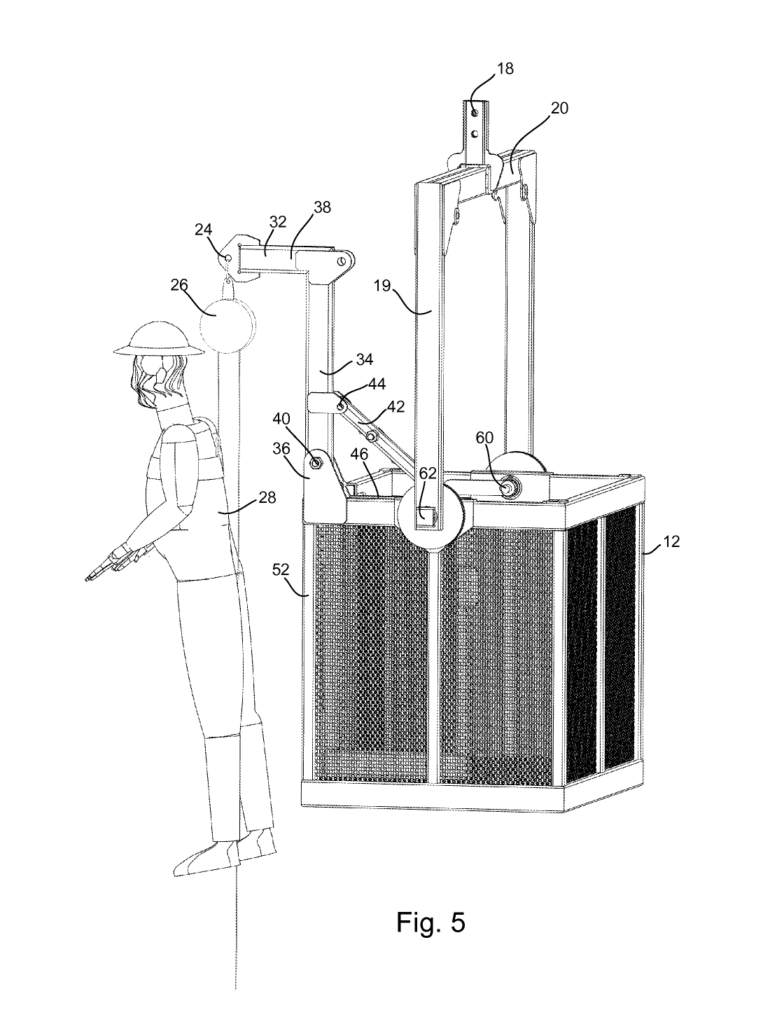

An eyelet 24 is secured to the cage 12 for receiving a descender 26 (FIG. 5). The eyelet 24 is positioned in relation to the cage 12 such that a line drawn downward from the eyelet 24 does not intersect the cage 12. In FIG. 5, this line is shown by the descender cable as it hands under gravity from the eyelet 24. This means that when a worker 28 is suspended in a harness 30 on a descender 26 from the eyelet 24 as shown in FIG. 5, the worker 28 will be free hanging without interfering with the cage 12. In the embodiment shown, the eyelet 24 is secured to a davit 32, for example by welding. The davit 32 may comprise a davit post 34 extending upward from the cage 12. The davit post 34 may be secured to a corner 36 of the cage 12. The davit 32 may include a davit arm 38. In this case, the eyelet 24 is on the davit arm 38. The davit arm 38 need not extend beyond the eyelet 24 so the eyelet 24 may be on the end of the davit arm 38. The davit arm 38 may extend outward from the cage 12 by at least 20 cm to space the eyelet 24 from the cage 12 by at least 20 cm and hence the descender 26 from the cage 12 when the descender 26 is hanging from the davit 32. The value 20 cm selected here is intended to be approximately a minimum shoulder width of a worker. When the eyelet 24 extends outward from the cage 12 by at least a shoulder width, the worker will have room to descend without hitting the cage and also, when the worker steps out from the cage 12 during an emergency, the worker will not swing back and hit the cage 12.

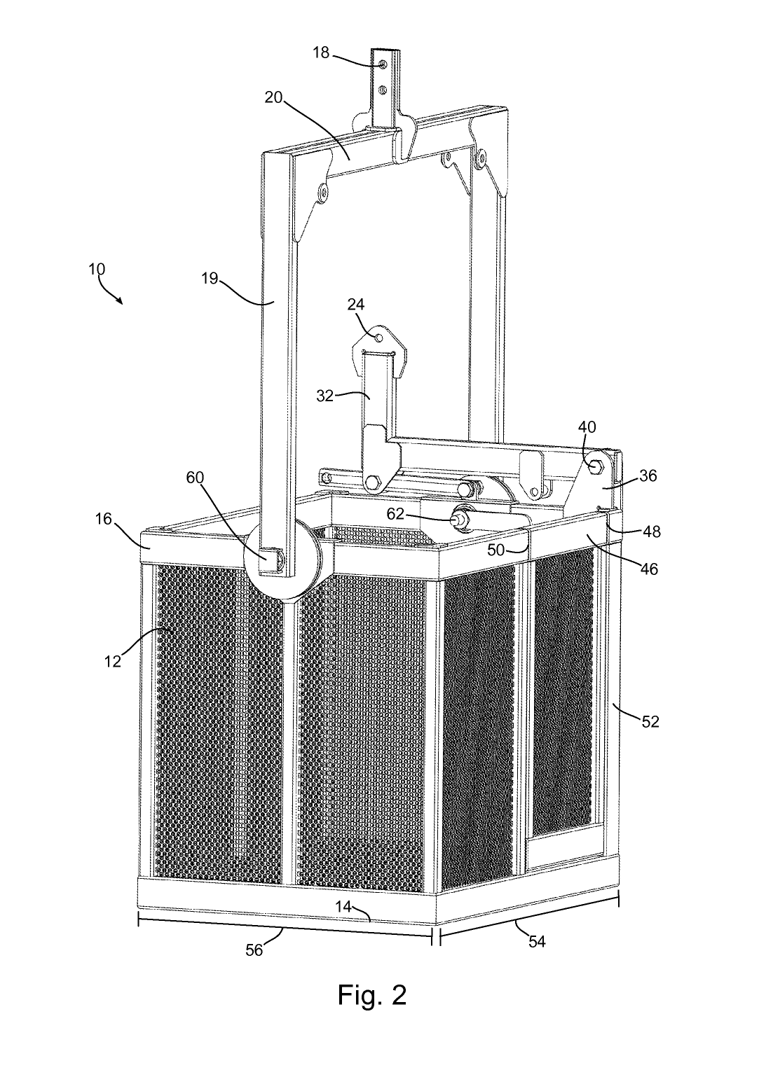

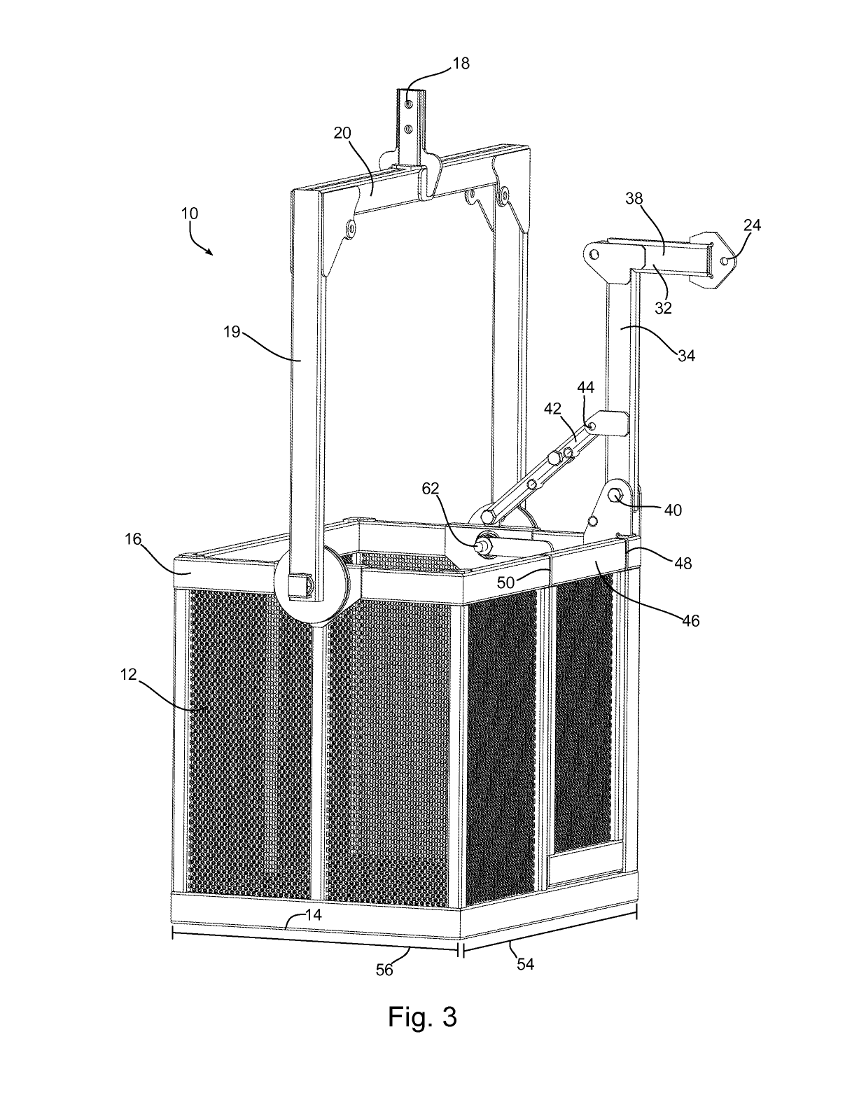

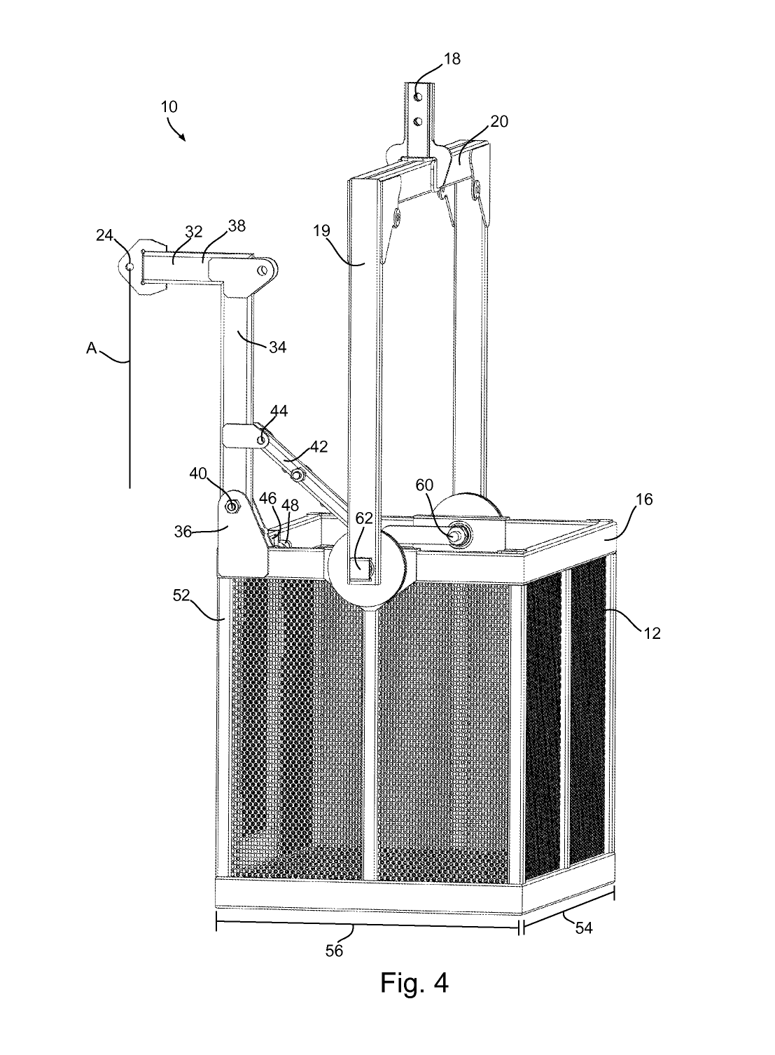

The davit post 34 may be pivotally attached to the cage 12 at a pivot 40. In this embodiment, the davit post 34 may pivot from a vertical position (FIGS. 3 and 4) to a horizontal position (FIGS. 1 and 2) for transportation. In the horizontal position, the davit post 34 may lie along the railing 16 of the cage 12. In the vertical position, the davit post 34 may be held upright by a brace 42 secured to the davit post 34 by a pin 44.

In an embodiment, the cage 12 has a door 46 with a hinge side 48 and a closure side 50. The door 46 may swing inward into the cage 12 or outward in different embodiments. The eyelet 24 may be located adjacent the door 46 at the hinge side 48 of the door 46 or the closure side 50 of the door 46. In the example shown, the door 46 may be hinged to a corner post 52 of the cage 12 and the davit post 34 extends upward from the corner post 52. The davit post 34 may for example be secured to the corner post 52 in this embodiment in any of various ways, such as by welding. The posts 34, 52 may be for example square tubes as shown or have other cross-sectional shapes.

In an embodiment, the cage 12 is rectangular with opposed longer sides 54 and shorter sides 56 and the door is on one of the longer sides 54 of the cage 12. The suspension frame 19 may be pivotally attached to the cage 12 at pivots 60, 62 on the shorter sides 56 of the cage 12. A container (not shown) carried by the cage 12 may be used for holding the descender 26, or the descender 26 may be attached to the davit 32 during operation of the elevated platform.

In accordance with standard safety requirements, the elevated platform may have one or more attachment points for a lanyard to secure a worker 28 to when the worker 28 is in the elevated platform. While a worker 28 is in the elevated platform and working above ground level, the davit 32 should be in the upright deployed position. For safety, the worker 28 should be wearing a safety harness while working In an emergency, the worker 28 should first retrieve the descender 26 from its container, secure the descender 26 to the safety harness, and then attach the descender 26 to the eyelet 24. The worker 28 may then detach the safety lanyard holding the worker 28 to the elevated platform (if the lanyard is being used), open the door 46 and step out into the position shown in FIG. 5. The worker 28 may then self-descend in accordance with normal descender operation.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. An elevated platform, comprising:
a cage having a floor and a railing;
one or more suspension points secured to an upper portion of the cage above the floor; and
an eyelet secured to the cage for receiving a descender, the eyelet being positioned in relation to the cage such that a line drawn downward from the eyelet does not intersect the cage.

2. The elevated platform of claim 1 in which the eyelet is secured to a davit.

3. The elevated platform of claim 2 in which the davit comprises a davit post extending upward from the cage.

4. The elevated platform of claim 3 in which the davit post is secured to a corner of the cage.

5. The elevated platform of claim 3 in which the davit includes a davit arm, the eyelet is on the davit arm and the davit arm extends outward from the cage by at least 20 cm to space the eyelet from the cage by at least 20 cm.

6. The elevated platform of claim 3 in which the davit post is pivotally attached to the cage.

7. The elevated platform of claim 6 in which the davit post pivots from a vertical position to a horizontal position.

8. The elevated platform of claim 7 in which, in the horizontal position, the davit post lies along the railing of the cage.

9. The elevated platform of claim 6 in which, in the vertical position, the davit post is held upright by a brace secured to the davit post by a pin.

10. The elevated platform of claim 1 in which the cage has a door with a hinge side and a closure side.

11. The elevated platform of claim 10 in which the eyelet is located adjacent the door at the hinge side of the door or the closure side of the door.

12. The elevated platform of claim 11 in which the eyelet is located at the hinge side of the door.

13. The elevated platform of claim 12 in which the door is hinged to a corner post of the cage and the davit post extends upward from the corner post.

14. The elevated platform of claim 10 in which the cage is rectangular with opposed longer sides and shorter sides and the door is on one of the longer sides of the cage.

15. The elevated platform of claim 1 in which the one or more suspension points comprises a connector on a suspension frame that is pivotally attached to the cage.

16. The elevated platform of claim 1 in which the cage has opposed shorter sides and longer sides, and the one or more suspension points comprises a connector on a suspension frame that is pivotally attached to the cage on the shorter sides of the cage.

17. The elevated platform of claim 1 in which the elevated platform is a man basket.
